(19) United States
(12) Patent Application Publication
(10) Pub. No.: US 2016/0339734 A1
(43) Pub. Date: Nov. 24, 2016

(54) Lottery Ticket with a Translucent Substrate

(71) Applicant: Pollard Banknote Limited, Winnipeg (CA)

(72) Inventors: Pierre Joseph Lavoie, Winnipeg (CA); Sindy Renee Catigay, Winnipeg (CA); Kristine Susan Wattis, Winnipeg (CA); Michael John Brickwood, Winnipeg (CA); Lyle Scrymgeour, Oakbank (CA); Julia Elizabeth Cloutier, Winnipeg (CA); Timothy George Edginton, Winnipeg (CA); Peter Nguyen, Winnipeg (CA); Brett Charles Taylor, Winnipeg (CA); Nancy Bettcher, Winnipeg (CA)

(21) Appl. No.: 14/718,666

(22) Filed: May 21, 2015

(51) Int. Cl. B42D 25/351

(52) U.S. Cl. CPC B42D 25/351

(57) ABSTRACT

A lottery ticket is printed on a substrate sheet material having a front surface with lottery game indicia printed thereon and a removable covering material, typically scratch-off material, covering the lottery game indicia which is removable by a player to expose the game indicia for playing the game and other game information printed on the substrate sheet material where at least part of the substrate sheet material is formed of a translucent synthetic material to enable viewing through the part by the player.

This invention relates to a lottery ticket where at least a part of the substrate carrying the lottery ticket information comprises a polymer film and particularly relates to scratch-off lottery tickets and the use of synthetic substrate material.

This invention further relates to a lottery ticket where at least a part of the substrate carrying the lottery ticket information is translucent or transparent.

This invention relates to a method of playing a lottery ticket game where at a second ticket when viewed through a translucent part of a first ticket is arranged so that a characteristic of the translucent part exposes data on the second ticket which is not visible when viewed without the translucent part.

### BACKGROUND OF THE INVENTION

Lottery tickets are well known and widely sold and typically comprise a sheet material of paper or card stock on which is printed lottery information and various indicia for the playing of one or more games. Many such games are instant win type games where the player can play the game or games by carrying out various functions. These include a first type of ticket which involves removing a scratch-off layer for scratch-off tickets. A second type of ticket involves opening pull tabs windows for what are known as break-open tickets. Such tickets are also known variously as pull-tabs, pickle cards, jar tickets, hard cards and charitable gaming tickets. Typically, these two distinct types of lottery tickets are targeted to different markets.

The break-open ticket is typically manufactured in a process which involves firstly printing using a printing press a full sheet which thus defines a set of the tickets in rows and columns which is laminated to a similar sheet of top sheet portions. The laminated sheets then must be cut in a mechanical cutting station into the individual ticket portions. The tickets thus formed are limited to the symbol combinations printed in the set. This leads generally to a reduced level of security for break-opens generally thus limiting the prize value which can be provided.

The present invention relates to both scratch-off and break-open tickets but is primarily concerned with scratch-off tickets where the substrate must also provide the necessary security characteristics such as opacity.

Scratch-off lottery tickets have up to date been printed on cardstock or foil laminated substrates for decades. Such substrates are typically relatively stiff and dimensionally stable to allow printing and to provide a finished product which remains generally flat when used by the player. This flat stiff structure enables the player to easily hold the ticket and hold the game area flat as the scratching process is applied.

Also the substrate used to date is opaque. It will be appreciated that the area containing the game data must be sufficiently opaque that it cannot be compromised by a strong light shone through the substrate and the game data. The degree of opacity to obtain this feature is typically assisted by printed layers of opaque material including a backing layer under the game data and the scratch-off material itself. Foil substrates are sufficiently opaque so that no additional layers are required although typically a white layer is applied beneath the game data to provide a higher contrast level between game indicia and the background. Card stock requires additional layers to provide the opacity required. However in all cases the substrate used has itself an initial high opacity level and other less opaque materials have thus been considered unsuitable.

Also the substrate must pass thought the printing process and allow the printing to be registered with a particular location on the substrate. Thus again foil substrates have a very high dimensional stability and hence are particularly desirable. Card stock has less dimensional stability and may stretch slightly but in a manner which can be managed in the printing process. Other less stable materials have thus been considered unsuitable.

As the substrate used to date therefore is either laminate stock including but not limited to foil laminates, transfer film laminates, etc. or card stock including various stock weights such as text weight and paper weight., aesthetic variation are limited to combinations of graphics, inks and coatings. In the continuing challenge to capture the attention of consumers in the cluttered retail environment, fast moving consumer packaged goods, including lottery tickets, rely on fresh new packaging options.

### SUMMARY OF THE INVENTION

It is one object of the invention to provide a ticket using a substrate of a new character so that novel features can be provided to the player using the characteristics of the substrate.

According to the invention there is provided a lottery ticket comprising:

a substrate sheet material having a front surface having lottery game indicia printed thereon;

a removable covering material covering the lottery game indicia which is removable by a player to expose the game indicia for playing the game;

game information printed on the substrate sheet material;

wherein at least part of the substrate sheet material comprises a polymer material.

Preferably the synthetic plastics material is translucent to enable viewing through said at least a part by the player.

According to a further aspect of the invention there is provided a lottery ticket comprising:

a substrate sheet material having a front surface having lottery game indicia printed thereon;

a removable covering material covering the lottery game indicia which is removable by a player to expose the game indicia for playing the game;

game information printed on the substrate sheet material;

wherein at least part of the substrate sheet material is translucent to enable viewing through said at least a part by the player.

Preferably the translucent material is arranged to have a character to change the appearance of an underlying object viewed through the translucent material. That is the material can be the colored or polarized or may have other characteristics which affect what is viewed underneath.

The ticket may also include the use of refractive synthetic material to provide a holographic appearance to all or a portion of the ticket.

The whole of the substrate can be formed by said material so that the game indicia and the covering is printed on the said material or a part only of the substrate is formed by said material.

Preferably the synthetic plastics material is laminated to another material and a part of the other material is omitted or removed to expose the synthetic plastics material.

For example the part removed may form a window in the ticket or a band across the ticket or any other shape within the main body of the ticket.

Preferably a part only of the substrate is formed by said material and another part is formed of a card or foil stock and the game indicia and the scratch-off or break-open covering is applied onto the other part.

Preferably the ticket is formed so that it has a dimensional stability and will be of similar caliper and stiffness so the ticket is relatively uniform

Preferably the translucent/plastics material is selected so that it has an opacity or can be made opaque with the use of opacifying chemistry to hide gaming indicia

Preferably the translucent/plastics material is selected so that it has an array of thickness to satisfy the end user's needs.

The translucent/plastics material can be of single material construction or made of multi-layers so that characteristics such as stiffness, dimensional stability and acceptance of printing can be selected and tailored to form a composite material.

According to another aspect of the invention there is provided a method of playing a lottery ticket game comprising:

providing a first and a second lottery ticket wherein each ticket comprises:
a substrate sheet material having a front surface having lottery game indicia printed thereon;
a removable covering material covering the lottery game indicia which is removable by a player to expose the game indicia for playing the game;
game information printed on the substrate sheet material;
wherein at least part of the substrate sheet material is translucent to enable viewing through said at least a part by the player;

and viewing the second ticket through a translucent part of the first ticket;

wherein the translucent part is arranged so that a characteristic of the translucent part of the first ticket combines with a characteristic of the viewed part of the second ticket.

As used herein, the surface with the game data on is termed as the front surface but this could be either the surface of a single substrate or on any one or more of the surfaces of a multi-layer ticket such as a folded or multi-page ticket.

For example the characteristic of the translucent part of the first ticket combines with the characteristic of the viewed part of the second ticket to expose data on the second ticket which is not visible when viewed without the translucent part.

Alternatively the characteristic of the translucent part of the first ticket combines with the characteristic of the viewed part of the second ticket to allow data on the second ticket to be combined with data on the first ticket.

As yet further alternatives, the characteristic of the translucent part of the first ticket combines with the characteristic of the viewed part of the second ticket to allow graphic or other elements of the second ticket to be combined with graphic or other elements of the first ticket to create new aesthetic effects or messages.

As yet further alternatives, the characteristic of the translucent part of the first ticket combines with the characteristic of the viewed part of another printed item such as a photograph or digital image to create new aesthetic effects or messages.

As yet further alternatives, the translucent portion(s) are covered in whole or in part with scratch-off layers or a tab so that the translucent portion is not usable or only partially visible until the ticket is purchased and played.

As yet further alternatives, multiple translucent films could be combined in a movable format such that they reveal or enhance part of the ticket experience when rotated or repositioned over each other.

As yet further alternatives, the translucent film combines with an encapsulated compound whereby applying the film to the ticket surface and rubbing the film causes the capsules to release a compound that would react with an invisible dye to make it visible.

As yet further alternatives, the translucent film can be folded over onto the same ticket to enhance another printed graphic element or the game play experience.

The term “translucent” as used herein includes materials where light can pass through the substrate so that this may include materials which are transparent where no light scattering occurs.

The invention is the use of a new substrate, comprising synthetic substrate(s) or a combination of synthetic substrate(s) with card stock and/or other types of opaque scratch-off lottery ticket substrate(s), to produce a distinctive looking lottery ticket. The new substrate, whether it is synthetic or a combination of synthetic and conventional scratch-off ticket substrate(s) will satisfy the physical security requirements commonly provided by conventional ticket substrates for scratch-off lottery tickets.

The synthetic substrate can be transparent, semi-opaque, colored and/or patterned. The scratch-off tickets feature an underlying layer or layers beneath the game data, which will provide the opacity requirements to prevent transmitted light compromise or other methods of compromise used with the application of various frequencies of lighting, filters and image capture and a layer or layers which will provide the contrast level between the background and game data to provide good legibility. In addition this combination of layers will also provide the adhesion characteristics necessary to bond the data to the synthetic substrate and compatibility with overlying security coatings designed to secure the variable data elements and provided the release characteristics required for scratch-off removal by player. Similarly portions of the synthetic substrate may be coated with underlying layer or layers to improve graphic appearance and durability of the graphic images. The synthetic substrate provides enhanced chemical resistance to compromise attempts from the back of the tickets compared to cardstock tickets.

Typical polymeric materials (sometimes known as plastics or synthetic materials) include as examples:

Polyester (PES).

Polyethylene terephthalate (PET).

Polyethylene (PE).

High-density polyethylene (HDPE).

Polyvinyl chloride (PVC).

Polyvinylidene chloride (PVDC).

Low-density polyethylene (LDPE).

Polypropylene (PP).

Polystyrene (PS).

Polycarbonate (PC).

Polymethyl methacrylate (PMMA) (Acrylic).

Polytetrafluoroethylene (PTFE).

Poly lactic acid (PLA)

Bioplastics

Biobased polymers

Recycled plastics

The material may be formed from one or more layers of these materials to provide the required characteristics defined herein.

For hybrid ticket combining the synthetic and conventional ticket substrates, the synthetic substrate may be printed with artistic images and/or game-related information or data and the card stock or other conventional ticket substrate contains the security layers, game indicia and scratch-off material. The synthetic and conventional ticket substrate(s) are laminated together such that the appearance and transparent or partially transparent quality of the synthetic printed portion is preserved in part or in its entirety, and the opaque, conventional stock portion(s) provides physical ticket security qualities in keeping with conventional scratch-off lottery tickets.

The tickets can be supplied in the form of continuous, fanfolded books with perforations separating the individual tickets. They can however also be provided as single tickets or sheets of tickets or rolls of tickets.

In the preferred embodiments, the new substrate enables interactivity between two or more tickets by overlaying the tickets and reading data, information or graphics printed on one ticket in combination with data, information or graphics printed on another ticket to form a new combination of data, information or graphics. Other embodiments are also possible, including but not limited to the use of the synthetic substrate as a decoder. In this embodiment, the synthetic substrate could be semi-opaque, tinted or patterned, and when over-laid on top of another ticket, could serve to decode hidden or scrambled information that may be related to the game play. The synthetic substrate provides a unique appearance for graphics and, optionally, game elements, and the ability to overlay one ticket on another to form a new graphic effect or new combination of information, potentially transforming a non-winning ticket into a winner.

The unique appearance of the synthetic ticket can catch attention at retail which drives sales for impulse products like lottery tickets. The unique tactile quality and optional ability to combine multiple tickets for an added entertainment or additional chances to win will create a higher perceived value for consumers, resulting in higher satisfaction and additional sales.

The tactile quality is obtained by selecting the characteristics so that the substrate is smooth and slick, giving the ticket a rich, high quality feel that is distinct from conventional scratch-off ticket substrates. It may also be textured or molded to add variety to the tactile sensation.

In one example the characteristic of the translucent part of the first ticket combines with the characteristic of the viewed part of the second ticket to enhance other images, create new graphic effects or decode hidden messages.

In one example the translucent material is patterned to enhance other images or create new visual effects or decode hidden messages.

The film preferably has the following characteristics:
Caliper=25 micron to 500 micron
Printable on one or both side of the substrate using lithography, flexography, gravure, screen and digital printing
Substrate service temperature: −70 C to 200 C
Specific gravity of the film(s): 1.0 to 1.5 g/cm3
Surface energy level of 30 to 60 dyne
Tensile Strength MD and TD>5 kg/mm2
Moisture adsorption<0.1 wt %
Tear strength>1 g/mil
Shrinkage<10%
Water and oil resistant as it pertains to security lab testing
Acid and alkali resistant as it pertains to security lab testing

### BRIEF DESCRIPTION OF THE DRAWINGS

FIG. 1 is a plan view of a first ticket according to the invention where the ticket substrate is formed from a plastics or synthetic material with the game data and removable covering printed on the substrate.

FIG. 2 is a plan view of a second ticket according to the invention where the ticket substrate is formed mainly from a conventional card stock which is laminated to a window area formed from a plastics or synthetic material with the game data and removable covering printed on the card stock.

FIG. 3 is a plan view of a third ticket according to the invention where the ticket substrate is formed mainly from a conventional card stock which is laminated to a window area formed from a plastics or synthetic material with the game data and removable covering printed on the card stock.

FIG. 4 is a cross-sectional view along the lines 4-4 of FIG. 1.

FIG. 5 is a cross-sectional view along the lines 5-5 of FIG. 2.

FIG. 6 is an alternative cross-sectional view along the lines 5-5 of FIG. 2.

FIG. 7 is a plan view of a first and second ticket according to the invention where the game data or other elements of the second ticket are viewed through the translucent window of the first ticket to reveal game data or other elements not otherwise visible.

### DETAILED DESCRIPTION

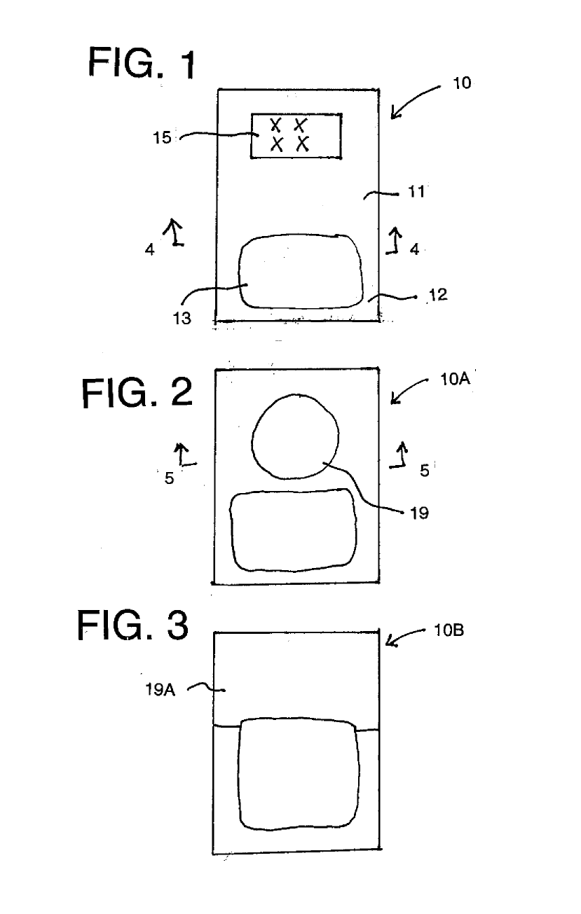

As shown in FIGS. 1, 2 and 3, there is provided a lottery ticket 10, 10A, 10B each of which includes a substrate sheet material 11 having a front surface 12 having lottery game indicia 13 printed thereon. A removable covering material 14 covers the lottery game indicia 13 which is removable by a player to expose the game indicia for playing the game. The front surface includes game information 15 printed on the substrate sheet material 11.

In each of the figures the removable covering comprises a scratch-off coating 14 typically printed over a release coating r and covered with over print 15. The game data is printed onto a security layer 16 which includes one or more pigmented layers to form an opacity to prevent transmission of light and which typically includes a white lily pad to provide a base to render the game data 13 more visible.

In another arrangement, the game data can be printed on one synthetic substrate and then laminated another synthetic substrate over top to protect the data.

In the present invention, at least part of the substrate sheet material comprises a synthetic plastics material 17. The plastics material can be formed of different layers 17A, 17B to provide the required characteristics as described herein.

As shown in FIG. 1, the whole of the substrate is formed by the plastics material so that the game indicia 13 and the covering 14 is printed on the material.

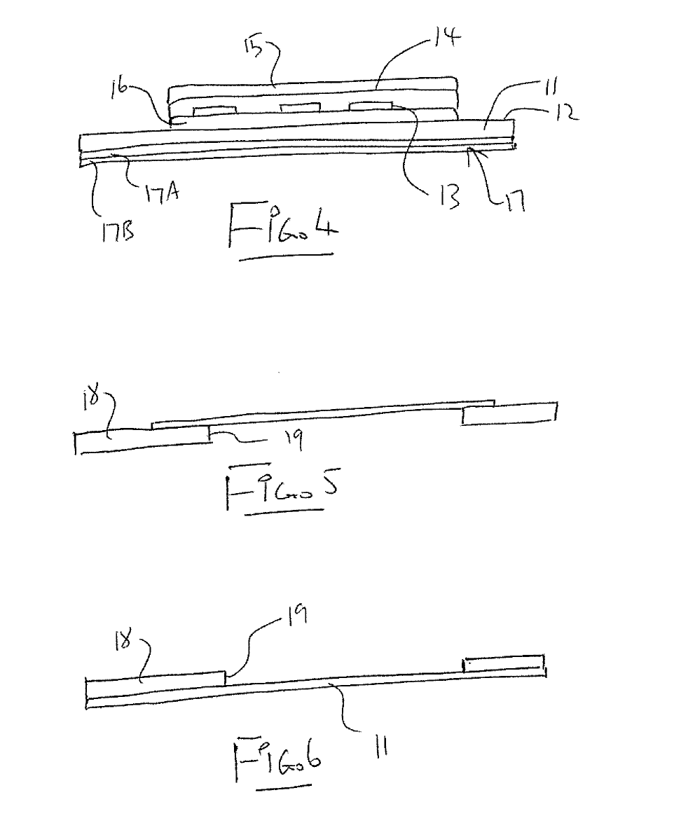

As shown in FIGS. 2 and 3, a part only of the substrate is formed by the material.

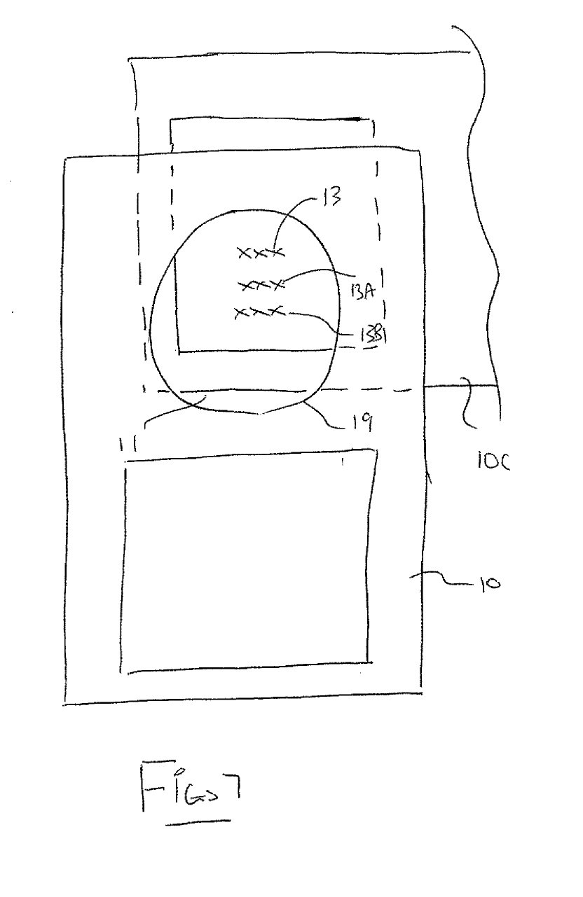

As shown in FIGS. 5 and 5 the synthetic plastics material 11 is laminated to another material 18 such as the card stock and a part of the other material is omitted or removed at an opening 19 to expose the synthetic plastics material 11. In FIG. 5 the part removed forms a window in the ticket. In FIG. 3 the part removed forms a band 19A across the ticket.

As shown in FIG. 7 the synthetic plastics material 11 in the window 19 is translucent to enable viewing by the player through the part of the substrate which is formed by the material. As shown a second ticket 100 is viewed through the window and the translucent material is arranged to have a character to change the appearance of an underlying object in this case the game data 13 viewed through the translucent material. That is additional data 13A may become or be made visible by the effect of the change made by the translucent material. Typically the translucent material is simply colored which then cooperates with colors on the game data to make the game data more or less visible.

However other characteristics in the material can be used such as the translucent material is polarized. Alternatively, the translucent material could be patterned to enhance other images or create new visual effects or decode hidden messages.

Where a part only of the substrate is formed by the plastics material and another part is formed of a card or foil stock and the game indicia and the covering is typically but not necessarily applied onto the other part as shown in FIG. 2 or 3.

In the method of playing a lottery ticket game shown in FIG. 7 using two of the tickets shown in FIG. 2 the player views the second ticket through the translucent part of the first ticket and the translucent part is arranged so that a characteristic of the translucent part of the first ticket combines with a characteristic of the viewed part of the second ticket to expose data on the second ticket which is not visible when viewed without the translucent part or acts to allow data on the second ticket to be combined with data on the first ticket where the data by placing one set of data 13B on the translucent material of the first ticket at or adjacent the data 13 on the underlying second ticket.

1. A lottery ticket comprising:
a substrate sheet material having a front surface having lottery game indicia printed thereon;
a removable covering material covering some or all of the lottery game indicia which is removable by a player to expose the game indicia for playing the game;
game information printed on the substrate sheet material;
wherein at least part of the substrate sheet material comprises a synthetic plastics or polymer material.

2. The lottery ticket according to claim 1 wherein the synthetic plastics material is translucent to enable viewing through said at least a part by the player.

3. A lottery ticket comprising:
a substrate sheet material having a front surface having lottery game indicia printed thereon;
a removable covering material covering some or all of the lottery game indicia which is removable by a player to expose the game indicia for playing the game;
game information printed on the substrate sheet material;
wherein at least part of the substrate sheet material is translucent to enable viewing through said at least a part by the player.

4. The lottery ticket according to claim 3 wherein the translucent material is arranged to have a character to change the appearance of an underlying object viewed through the translucent material.

5. The lottery ticket according to claim 3 wherein the translucent material is colored.

6. The lottery ticket according to claim 3 wherein the translucent material is polarized.

7. The lottery ticket according to claim 3 wherein the translucent material is patterned or that may refract light in order to reveal a hidden feature on the ticket.

8. The lottery ticket according to claim 3 wherein the whole of the substrate is formed by said material so that the game indicia and the covering is printed on the said material.

9. The lottery ticket according to claim 3 wherein a part only of the substrate is formed by said material.

10. The lottery ticket according to claim 9 wherein the synthetic plastics material is laminated to another material and a part of the other material is omitted or removed to expose the synthetic plastics material.

11. The lottery ticket according to claim 10 wherein the part removed forms a window in the ticket.

12. The lottery ticket according to claim 10 wherein the part removed forms a band across the ticket.

13. The lottery ticket according to claim 3 wherein a part only of the substrate is formed by said material and another part is formed of a card or foil stock and the game indicia and the covering is applied onto the other part.

14. The lottery ticket according to claim 3 wherein the translucent/plastics material is multi-layer.

15.-21. (canceled)

22. Lottery game apparatus comprising:
a lottery ticket according to claim 3:
a window in the ticket through said translucent part;
a second support material carrying a component to be viewed through said translucent part of the ticket;
wherein the translucent part is arranged so that a characteristic of the translucent part of the first support material combines with a characteristic of the viewed component.

23. The apparatus according to claim 22 wherein the characteristic of the translucent part of the ticket combines with the characteristic of the viewed component to expose data on the second support material which is not completely visible when viewed without the translucent part.

24. The apparatus according to claim 22 wherein the characteristic of the translucent part of the ticket combines with the characteristic of the component to enhance other images, create new graphic effects or decode hidden messages.

25. The apparatus according to claim 22 wherein the translucent material is colored.

26. The apparatus according to claim 22 wherein the translucent material is polarized.

27. The apparatus according to claim 22 wherein the translucent material is patterned to enhance other images or create new visual effects or decode hidden messages.

28. Lottery game apparatus comprising:
a lottery ticket according to claim 3:
a window in the ticket through said translucent part;
a second support material carrying additional game indicia to be viewed through said window in said translucent part of the ticket;
wherein the translucent part of the ticket is arranged to allow said additional game indicia on the second support material to be combined with the game indicia on the ticket.

29. The apparatus according to claim 29 wherein game indicia on the translucent material of the ticket are arranged on the ticket such that the game indicia are placed at or adjacent to the additional game indicia on the second support material when viewed.
